(19) United States
(12) Patent Application Publication
(10) Pub. No.: US 2011/0236157 A1
(43) Pub. Date: Sep. 29, 2011

(54) BOOK BINDING TOOL

(75) Inventors: Gary P. Metzgar, Jasper, IN (US); Joseph E. Wright, Jasper, IN (US)

(73) Assignee: LEITZ TOOLING SYSTEMS, INC., Jasper, IN (US)

(21) Appl. No.: 12/825,997

(22) Filed: Jun. 29, 2010

Related U.S. Application Data
(60) Provisional application No. 61/316,603, filed on Mar. 23, 2010.

(51) Int. Cl. B42C 5/04

(52) U.S. Cl. 412/1; 412/16

(57) ABSTRACT

Reversible or indexable cutting knives are mechanically attached to at least one of a leveler saw and a roughing tool for a perfect or patent binding operation. In one embodiment, each reversible or indexable knife has multiple cutting edges. The cutting edges of the reversible or indexable knife may be arranged around the knife such that the knife can be rotated to a different position to replace a worn cutting edge with a new cutting edge on the same knife. The knives may be attached in recesses in the roughing tool or leveler saw.

### BACKGROUND OF THE INVENTION

The present invention relates to perfect or patent binding tools, and more particularly to a leveler saw and a roughing tool for a perfect binding operation.

Perfect binding is a common method for binding a wide variety of articles, such as paperback books, magazines, catalogs, directories and the like. In the perfect binding process, a group of folded pages that comprise a book or other article to be bound are typically placed in a clamp for preparing the edge of the book that is to be the binding edge. The edge is initially cut with a cutting tool, often referred to as a leveler saw, to remove the folds on the binding edge. After the folds have been removed, the binding edge is scored or roughed with a roughing tool to provide the binding edge with a textured surface. The textured surface provides an increased surface area on the binding edge for receiving an application of glue.

The leveler saw and roughing tool are commonly rotary tools that are mounted to a book binding machine. The leveler saw and roughing tool are activated to rotate at high velocities, and the clamped books are transported past the leveler saw and the roughing tool, for example, by moving clamped books along a conveyor system past the leveler saw and the roughing tool in proximity to the leveler saw and roughing tool.

One difficulty associated with leveler saws and roughing tools alike is the fact that they tend to wear out over time. In many cases, the leveler saw and roughing tool include brazed cutting knives attached around their outer peripheral edges. The cutting knives rotate with the cutting tools such that their leading edge becomes the cutting surface. Over time, and after cutting or roughing the binding edge of many books, the cutting surface on each of the knives wears down, and some of the knives may even break off completely. This eventually requires a complete replacement of the cutting tools, which can be costly and can reduce productivity as the book binding machines must be shut down for the amount of time necessary to replace the tools.

### SUMMARY OF THE INVENTION

The present invention provides reversible or indexable cutting knives that are mechanically attached to at least one of a leveler saw and a roughing tool for a perfect or patent binding operation. In one embodiment, each reversible or indexable knife has multiple cutting edges. The cutting edges of the reversible or indexable knife may be arranged around the knife such that the knife can be rotated to a different position to replace a worn cutting edge to a new cutting edge.

In one embodiment, the leveler saw and the roughing tool each include a central portion and a circumferential edge. The central portion may be configured to be mounted to a binding machine, wherein the tool is capable of being rotated with respect to the binding machine. The circumferential edge extends around said central portion, and the roughing tool and leveler saw each include a plurality of recesses defined adjacent to their circumferential edge. The recesses may be spaced apart about the circumferential edge. The cutting knives can be removably attached to the tool, with each cutting knife disposed in one of the recesses, wherein each cutting knife is capable of being removed from the recess, and reattached to the within said recess in a different angular position with respect to said recess.

In one embodiment, each reversible or indexable knife is square, with four perimeter cutting edges and a central fastener hole for attaching the reversible or indexable knives to at least one leveler saw and one the of the roughing tool. The reversible or indexable knife may be interchangeable between the leveler saw and the roughing tool.

The present invention further includes a method for a book binding tool including the steps of: (a) providing a roughing tool having a front surface, a rear surface, a circumferential edge and a plurality of roughing tool recesses defined in the circumferential edge; (b) providing a leveler saw having a front surface, a rear surface, a circumferential edge and a plurality of leveler saw recesses adjacent the circumferential edge; (c) providing a plurality of cutting knives, each cutting knife having multiple cutting edges; (d) attaching one of the cutting knives into each roughing tool recess in a first position; (e) attaching one of the cutting knives into each leveler saw recess in a first position; (f) attaching the roughing tool to a machine with the front surface facing a first direction, the roughing tool attached to the machine such that it can rotate about an axis with respect to the machine; (g) attaching the leveler saw to a machine such that it can rotate about an axis with respect to the machine; (h) rotating the roughing tool and the leveler saw; (i) removing at least one of the cutting knives from the roughing tool or the leveler saw; and (j) reattaching the cutting knife to the roughing tool of leveler saw in a second position that is different from the first position.

### BRIEF DESCRIPTION OF THE DRAWINGS

FIG. 1 is a perspective view of a roughing tool according to one embodiment of the present invention.

FIG. 2 is a close up view of a portion of the roughing tool.

FIG. 3 is a close up exploded view of an indexable knife and a portion of the roughing tool.

FIG. 4 is a front cross sectional view of the roughing tool.

FIG. 5 is a top view of an indexable knife and a portion of the roughing tool

FIG. 7 is a close up view of a portion of the roughing tool according to the second embodiment.

FIG. 8 is a perspective view of the roughing tool according a third embodiment.

FIG. 9 is a side view of the roughing tool according to the third embodiment.

FIG. 10 is a perspective view of the roughing tool attached to a perfect binding machine.

FIG. 11 is a front perspective view of a leveler saw according to one embodiment of the present invention.

FIG. 12 is a rear perspective view of the leveler saw.

FIG. 13 is a close up exploded view of an indexable knife and a portion of the leveler saw.

FIG. 14 is a close up rear view of a the indexable knife and a portion of the leveler saw.

FIG. 15 is a close up front view of a the indexable knife and a portion of the leveler saw.

FIG. 16 is a side cross sectional view of the leveler saw.

FIG. 17 is a front view of the leveler saw according to a second embodiment.

FIG. 18 is a close up view of the leveler saw according to the second embodiment.

FIG. 19 is a side cross sectional view of a leveler saw according to the second embodiment.

FIG. 20 is a perspective view of the leveler saw attached to a perfect binding machine.

### DETAILED DESCRIPTION OF THE CURRENT EMBODIMENT

### I. Overview

A leveler saw (generally designated 50) and a roughing tool (generally designated 10), and a according to one embodiment of the present invention are disclosed in the Figs. The roughing tool 10 and the leveler saw 50 are designed to be fitted onto a perfect or patent binding machine for a binding operation. More particularly, they are mounted to the machine in such a way that they rotate adjacent to the pathway of a series of moving “signatures” or “books” (multiple folded pages held tightly together by clamps) that are transported past the leveler saw 50 and the roughing tool 10. The leveler saw 50 is used to shear off the fold area of each signature group in order to “expose the individual pages” and to “square up or level the spine or backbone” of the signatures. The clamped signatures are then passed over the roughing tool 10 in order to score or roughen the spine or backbone of the clamped signatures. The roughing operation performed by the roughing tool 10 is done in order to increase the surface area by roughening the spine or backbone to expose the paper fibers which will facilitate better glue adhesion for the proceeding cover application.

In one embodiment, the circumferential edge of the leveler saw 50 and the roughing tool 10 include multiple, spaced apart, reversible or indexable knives 12 that are mechanically affixed to the leveler saw 50 and the roughing tool 10. Each reversible or indexable knife 12 can be rotated with respect to the outer edge of the tool to expose a new cutting surface, or removed from the tool to be replaced with another reversible or indexable knife 12. Each individual reversible or indexable knife 12 may have multiple cutting edges, such that the knife 12 can be rotated to prolong its useful life. In one embodiment, the same reversible or indexable knives 12 are designed to attach to either the leveler saw 50 or the roughing tool 10 such that they may be interchangeable.

### II. Structure

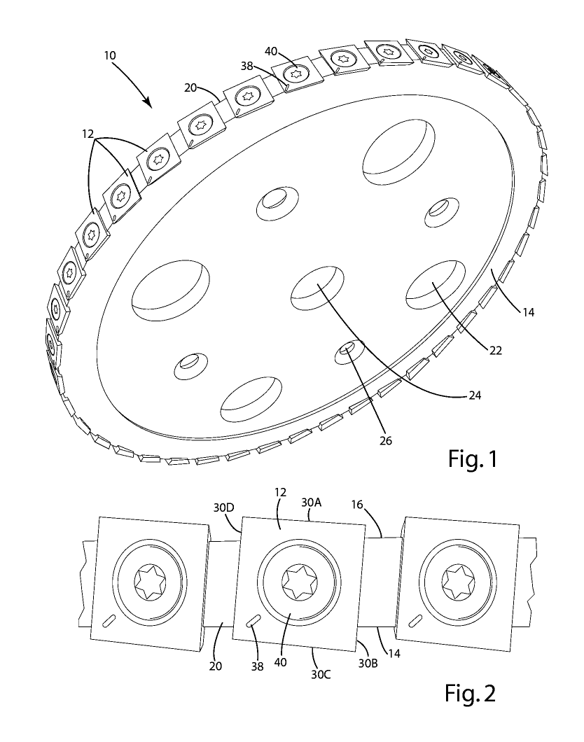

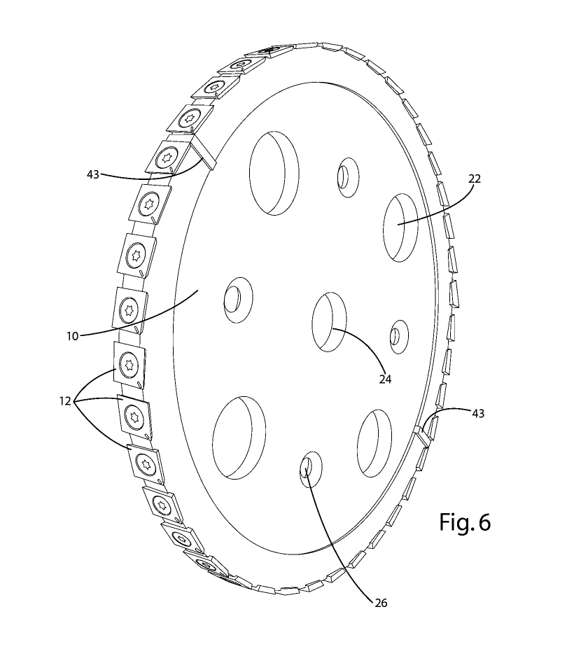

As shown in FIGS. 1-10, the roughing tool 10 is generally circular, and includes a front surface 14, a rear surface 16 opposite the front surface, and a circumferential edge 20. The tool 10 may be made from a variety of materials, such as steel, aluminum or other metal materials or composites. In the illustrated embodiment, the tool 10 has a diameter of about 9.291 inches (236 mm) and a thickness—defined between the front 14 and rear 16 surfaces—of about 0.4 inches (10.16 mm), however, a variety of alternative diameters and thicknesses may be used, depending on the application or machine type. Also in the illustrated embodiment, the tool 10 includes a thickened region proximate to the circumferential edge 20 and a series of holes extending through the front 14 and rear 16 surfaces. As shown, the tool 10 includes five larger holes, including a central bore hole 24 and four generally evenly spaced perimeter holes 22 for the use of another attachment mounted below tool 10 called “slasher” knives (not shown). The tool 10 also includes four smaller countersunk mounting holes 26 that, in one embodiment, are used to receive fasteners for attaching the tool 10 to the machine. A variety of hole arrangements and attachment arrangements may alternatively be used.

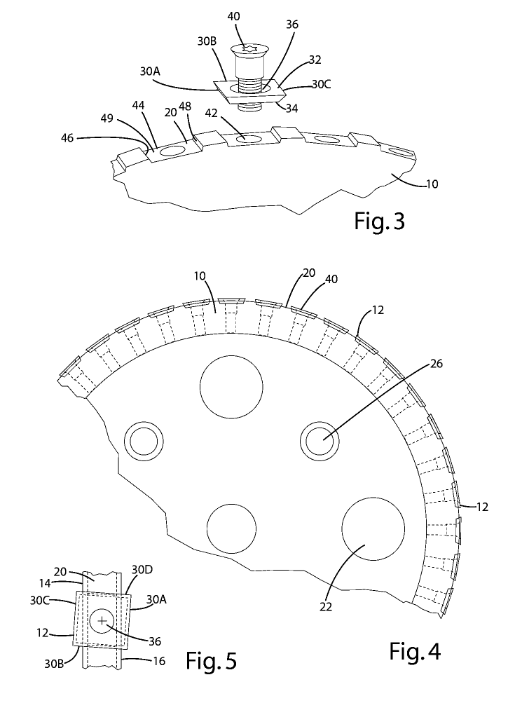

In one embodiment, multiple reversible or indexable knives 12 are attached to the circumferential edge 20 of the roughing tool 10. More particularly, as shown in FIGS. 1-10, the tool 10 includes forty (40) reversible or indexable knives 12 spaced approximately evenly about the circumferential edge 20 of the tool 10. Of course, the number and spacing of the reversible or indexable knives 12 may vary by machine and application. The knives 12 are generally square, forming a perimeter with four cutting edges 30a-d, an upper surface 32, and an opposing lower surface 34. Additional shapes may otherwise be used, such as a rectangle, triangle, or a shape with more than four cutting edges. The dimensions of the knife 12 may vary, but in the illustrated embodiment, the knives 12 are wider than the distance between the front 14 and rear surfaces 16 of the tool 10, such that portions of each knife 12 extend beyond the front 14 and rear 16 surfaces of the tool 10. In one embodiment, shown in FIGS. 3-4, the cutting edges 30a-d may be beveled, such that each cutting edge 30a-d is undercut from the upper surface 32 to the lower surface 34. The angle of the undercut may vary; however, the angle is predetermined in order to control the positioning of the knives 12 with respect to the tool 10 when the knife 12 is disposed on the tool 10. Each knife may additionally include a fastener hole 36 extending through the knife 10 from the upper surface 32 to the lower surface 34. As shown, the fastener hole 36 is countersunk, and is positioned in the center of the knife 12 such that the fastener hole 36 is equidistant from each of the cutting edges 30a-d. This allows the cutting knife 12 to be rotated with respect to the roughing tool 10 without having to reposition the signatures with respect to the roughing tool 10. In one embodiment, each reversible or indexable knife 12 includes a witness mark 38 on the upper surface 32 for reference by the user when rotating the reversible or indexable knives 12 with respect to the tool 10.

The reversible or indexable knives 12 may be attached to the roughing tool 10 by fasteners 40 extending into fastener holes 42 in the circumferential edge 20. As shown in FIGS. 3-4, the fastener holes 42 extend into the circumferential edge 20 in a generally radial direction, with the holes 42 being approximately evenly spaced apart. Each hole 42 is positioned within a recess 44 in the circumferential edge 20, the recess 44 including a first wall 46, a second wall 48, and a bottom 49. The walls 46, 48 and the bottom 49 cooperate to properly orient or “seat” the reversible or indexable knife 12, with the beveled cutting edges 30a-d contacting the walls 46, 48 and the lower surface 34 of the reversible or indexable knife 12 contacting the bottom 49. In the illustrated embodiment, the reversible or indexable knives 12 are attached to the circumferential edge 20 with the cutting edges 30a-d oriented at an angle to the upper 14 and lower 16 surfaces of the tool 10. More particularly, the reversible or indexable knife 12 of the illustrated embodiment are oriented at a 5 degree angle with respect to the upper 14 and lower 16 surfaces although the angle may vary. In one embodiment, the walls 46, 48 of each recess are parallel, and are angled with respect to the upper and lower surfaces 14, 16 at approximately the desired angle of the cutting edges 30a-d. The reversible or indexable knives 12 can be made from a variety of materials, and are typically constructed from tungsten carbide, Cermet, ceramic, titanium nitrate, steel, or another material capable of cutting through the “spine” or “backbone” of a group of signatures. The fasteners 40 extending through the fastener holes 42 may be conventional threaded fasteners that extend into the fastener holes 42 in the tool 10. The fastener holes 42 may likewise be threaded to receive the fasteners 40. In one embodiment, the fastener holes 42 are milled or drilled to a predetermined depth that will allow the fasteners 40 to seat within the countersink in each of the reversible or indexable knives 12.

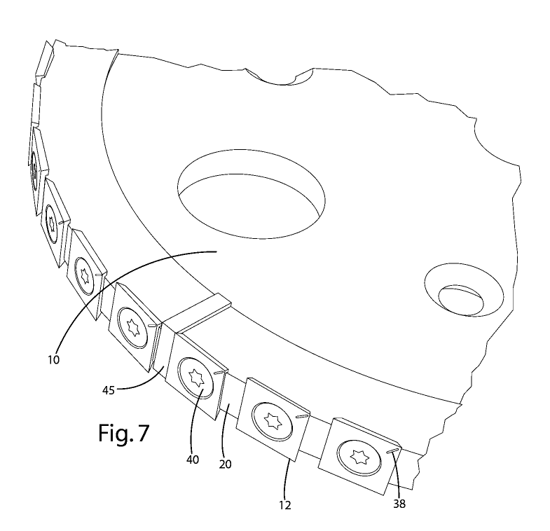

In one embodiment, shown in FIGS. 6-7, the roughing tool 10 may additionally include a pair of diametrically opposing notches 43 extending into the tool through the circumferential edge 20. In one embodiment, the notches 43 may extend completely through the tool 10, from the front surface 14 to the rear surface 16. Alternatively, the notch may extend through only one of the front 14 and rear 16 surfaces. A wiper or “raker” 45, shown in FIG. 7, may be attached within each notch 43. The wipers 45 may be configured to extend outwardly from at least one of the front 14 and rear 16 surfaces. In this way, the wipers 45 are capable of creating air turbulence to facilitate the removal of excess dust or paper particles from the spine or backbone of the grouped signatures as it is scored by the roughing tool 10. The removal of excess particles can increase the bond or adhesion between the spine or backbone and the cover applied in the next station of perfect or patent binding. In an alternative embodiment, the roughing tool 10 may include only one notch 43 and one wiper 45, or more than two notches 43 and wipers 45.

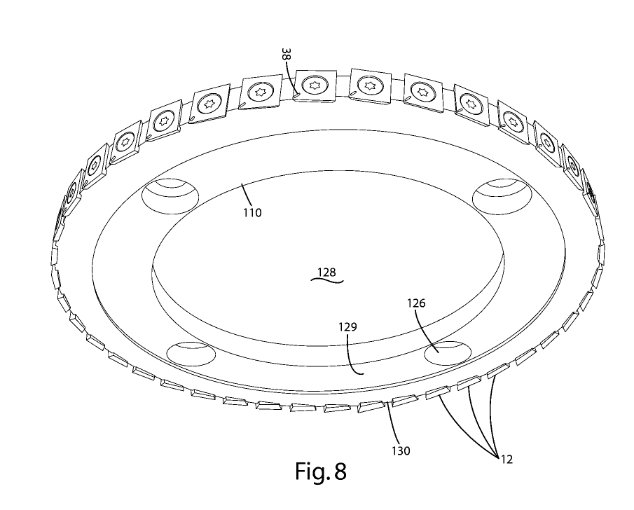

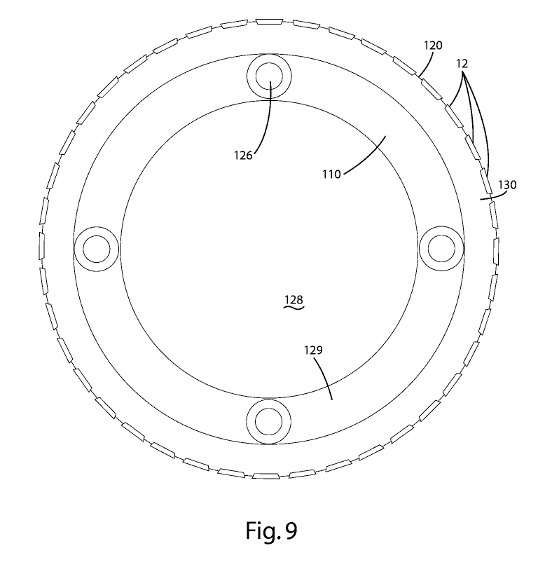

FIGS. 8-9 illustrate another alternative embodiment of the roughing tool 110 for use with the reversible or indexable knives 12. In this embodiment, the tool 110 includes four generally evenly spaced mounting holes 126 for receiving fasteners for attaching the tool 110 to a machine. The tool 110 includes a central bore 128 defined by an inner portion 129 having a thickness of about 0.589 inches, and first and second faces 140, 160. The tool 110 includes a peripheral portion 130, including a peripheral edge 120, the peripheral portion 130 and peripheral edge 120 are offset with respect to the inner portion 130 toward the edge 140, defining a step or hub 132 at the outer edge of the inner portion 130 at the surface 160. The tool 110 receives the individual reversible or indexable knives in the same manner as the tool 10 described above. This alternative configuration of the tool enables the tool 110 to be attached to a particular variation of a perfect binding machine while still utilizing the knives 12.

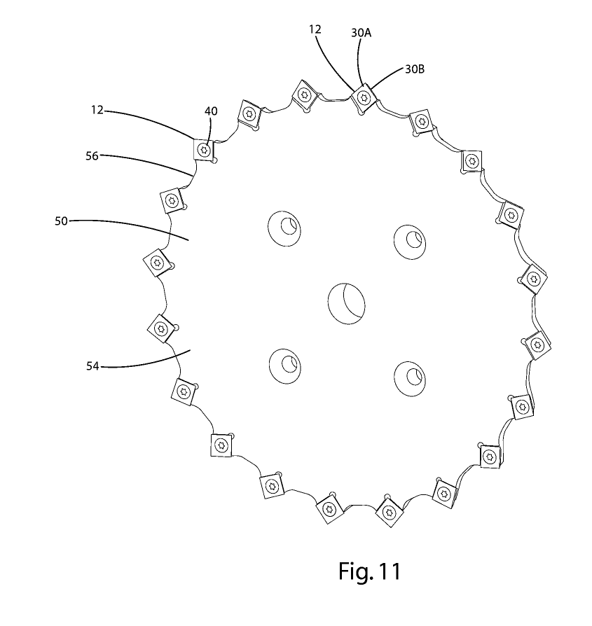

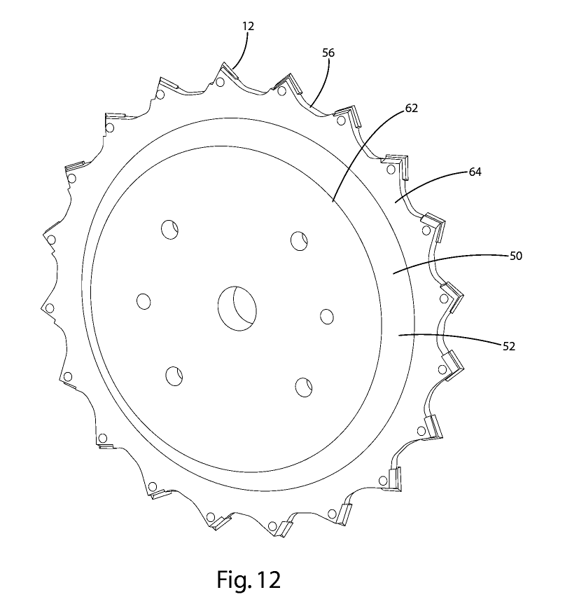

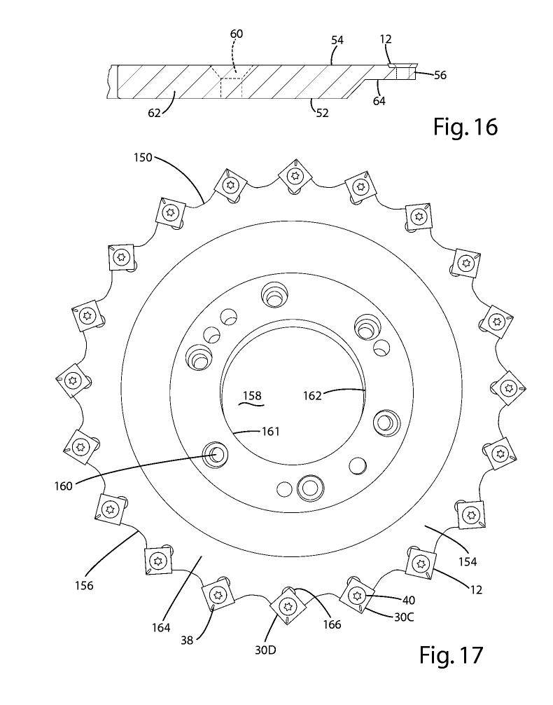

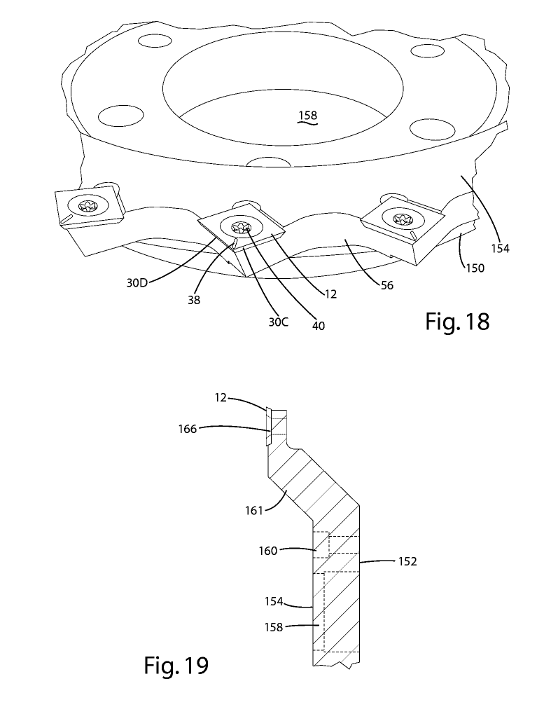

Referring now to FIGS. 11-20, the leveler saw 50 is also generally circular, including a rear surface 52, a front surface 54 opposite the rear surface 52, and a circumferential edge 56. The leveler saw 50 may be made from a variety of materials, including the same materials that may be used for the roughing tool 10. In addition, the leveler saw 50 may include multiple through holes, similar to the roughing tool 10. As shown, the leveler saw 50 includes a central bore hole 58 and four perimeter holes 60 spaced about the central hole 58. One of more of the holes 60 may be used to secure the leveler saw 50 to the perfect or patent binding machine 100 by a conventional method, to enable rotation of the leveler saw 50 about a central axis or spindle. Although both the front 54 and rear 52 surfaces may be flat, in the illustrated embodiment, the rear surface 52 includes a central portion 62 that is raised from a perimeter portion 64, whereas the front surface 54 is generally flat.

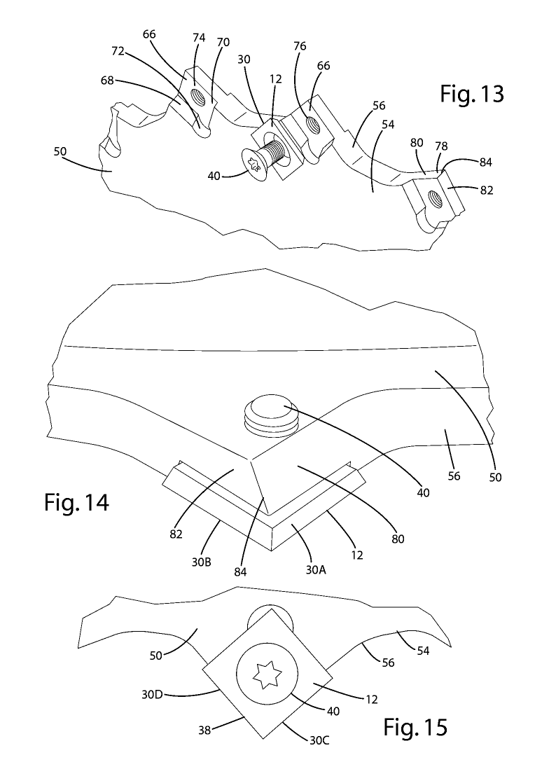

The reversible or indexable knives 12 affixed to the leveler saw 50 may be the same as the knives 12 affixed to the roughing tool 10; however, in one embodiment, the reversible or indexable knives 12 are affixed to the leveler saw 50 with the lower surface 34 of the reversible or indexable knives 12 contacting the front surface 54 of the leveler saw 50. As shown in FIG. 13, in one embodiment, the leveler saw 50 includes a plurality of recesses 66 extending into the front surface 54 that are spaced approximately evenly about the perimeter of the leveler saw 50. Each recess 66 includes a first wall 68 and a second wall 70 that support two of the cutting edges 30a-d of a reversible or indexable knife 12. As illustrated, the walls 68, 70 converge toward a rounded seat 72 at the base of each recess 66. Each recessed area 66 additionally includes a bottom 74, which includes a fastener hole 76 extending through the saw 50. The circumferential edge 56 may include a plurality of outwardly extending protrusions 78 spaced approximately evenly apart, with each protrusion corresponding to one of the recessed areas 66 for receiving a reversible or indexable knife 12. As shown, each protrusion 78 is generally triangular, including a first exterior wall 80 and a second exterior wall 82 that converge to a point 84 opposite the base of the recess 66. The fasteners 40 extend through the holes 36 in the reversible or indexable knives 12 and the holes 76 in the saw 50 to attach the reversible or indexable knives 12 to the front surface 54 of the saw 50. In the illustrated embodiment, each reversible or indexable knife 12 is positioned in a recess 66 with two of the cutting edges 30a-d in contact with the two walls 68, 70 of the recess respectively. The remaining two cutting edges 30a-d extend beyond the exterior walls 80, 82 of a protrusion such that they can contact the spine or backbone of the grouped signatures to shear off a portion of the folded edges as they are transported past the leveler saw 50.

FIGS. 17-19 illustrate an alternative embodiment of the leveler saw 150 for use with the reversible or indexable knives 12. The leveler saw 150 includes a front surface 154, a rear surface 152, a central portion 162 and a peripheral portion 164. The peripheral portion 164, including the peripheral edge 156 and the spaced apart recesses 166, are substantially the same as the peripheral portion 64 of the leveler saw 50, such that the recesses 166 are capable of receiving the knives 12. In this embodiment, the central portion 162 of the saw 150 includes a central bore 158, and a plurality of mounting holes 160 spaced apart around the central bore 158. The saw 150 includes a transition portion 161 that extends on an angle between the central portion 162 and the peripheral portion 164 to offset the front surface 154 in the peripheral portion 164 from the rear surface 152 in the central portion 162 by about 1.8 inches. This configuration of the leveler saw 150 enables the attachment of the leveler saw 150 to a particular perfect binding machine. In another alternative embodiment, the leveler saw 150 and the roughing tool 110 may be provided with other configurations in order to enable attachment of a leveler saw and roughing tool with the knives 12 to other perfect binding machines. Each of these configurations of the roughing tool may be adapted to include a wiper/raker as described above.

### III. Operation

Operation of the roughing tool 10 and leveler saw 50 of the present invention includes attaching a plurality of reversible or indexable knives 12 to the roughing tool 10 by inserting fasteners 40 through the fastener hole 36 in each reversible or indexable knives 12 and into one of the fastener holes 42 in the circumferential edge 20 of the tool 10. Each fastener 40 is tightened, for instance, by screwing the threads on the fastener 40 into corresponding threads within the fastener hole 42, until the reversible or indexable knives 12 is properly seated between the walls 46, 48 of the recess 44 and on the bottom 49 of the recess 44. As the reversible or indexable knives 12 are individually fastened to the tool 10, the witness mark 38 of each reversible or indexable knife 12 can be aligned in the same direction, such that a user will know that the reversible or indexable knives 12 are on their first rotation. Similarly, a plurality of reversible or indexable knives 12 are attached to the leveler saw 50 by inserting fasteners 40 through the fastener hole 36 of each reversible or indexable knife 12 and into a fastener hole 76 in the leveler saw 50. The witness mark 38 of each reversible or indexable knife 12 may be oriented in a similar direction. In the illustrated embodiment, the reversible or indexable knives 12 are interchangeable between the roughing tool 10 and the leveler saw 50.

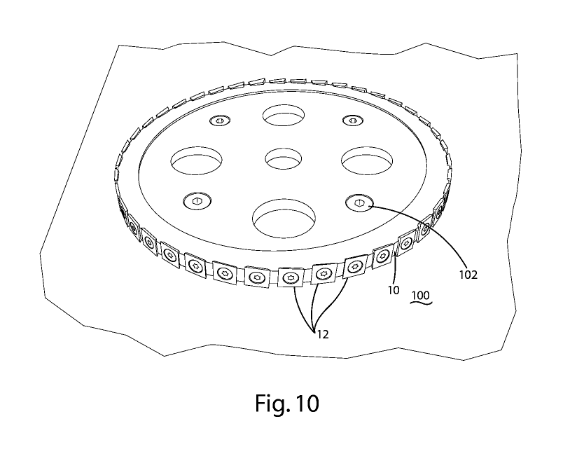

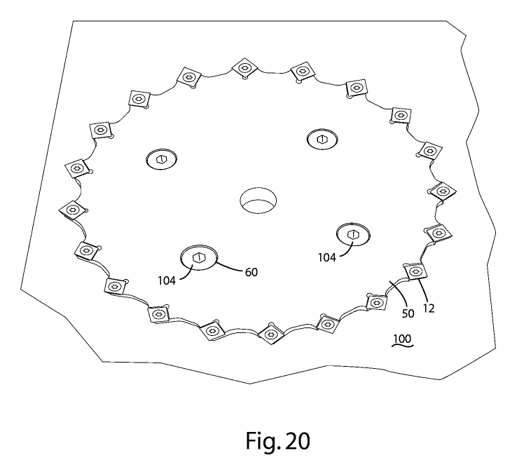

The roughing tool 10 and the leveler saw 50 are attached to the book binding machine 100 by a conventional attachment method. As shown in FIGS. 10 and 20, the roughing tool 10 may be attached to the machine 100 by bolts 102 extending through the holes 26 in the tool 10 and the leveler saw 50 may be attached to the machine 100 by bolts 104 extending through the perimeter holes 60. The roughing tool 10 and leveler saw 50 are mounted to the machine such that they can be rotated about their respective center points.

Once the roughing tool 10 and the leveler saw 50 have been attached to the machine 100 and the reversible or indexable knives have been attached to the roughing tool 10 and leveler saw 50, the saw 50 and tool 10 can be rotated by the machine for use in the perfect binding process. First, the combined signatures are transported past the leveler saw 50, such that one of the exposed cutting edges 30a-d (depending on the direction of rotation) contacts the spine or backbone of the book to shear off the folds of the pages. The grouped signatures may then be transported past one of the surfaces 14, 16 of the roughing tool 10, such that the cutting edges 30a-d of the reversible or indexable knives 12 extending beyond that surface 14, 16 engage the recently cut spine or backbone to score or roughen the cut surface from the saw for preparation of an adhesive. If the embodiment of the roughing tool 10 including the wipers 45 is used, the wipers 45 are capable of creating air turbulence to facilitate the removal of excess dust/paper particles from the spine or backbone of the grouped signatures as it is scored by the roughing tool 10.

After a period of machine usage, the particular cutting edges 30a-d on the tool 10 and saw 50 that have been engaging the grouped signatures may wear down. When this happens, the reversible or indexable knives 12 of both the saw 50 and the tool 10 can be rotated to expose another, previously unused, cutting edge 30a-d.

In one embodiment, the roughing tool 10 or the rougher tool with wiper 45 shown in FIG. 7 can turned over (flipped or reversed) such that a second one of the surfaces 14, 16 faces the base of the machine. This process can be done without removing the reversible or indexable knives 12 by removing the fastening screws used in holes 26 and flipping the entire tool 10 over. Once the body of roughing tool 10, or the rougher tool with raker 45 shown in FIG. 7, is reversed, the opposite corners (180 degrees from the previously used corner) are positioned to engage the spine or backbone and used for further use on the perfect or patent binding machine. After this rotation has been done, the reversible or indexable knives 12 may additionally be rotated (180 degrees) to expose a third edge 30a-d by removing each individual reversible or indexable knife via its fastener 40, and rotating it with respect to the tool 10 to expose another cutting edge 30a-d. Finally, a fourth cutting edge 30a-d of each reversible or indexable knife may be exposed for use by reversing the tool 10 a second time with respect to the machine 100, such that the first one of the surfaces 14, 16 again faces the machine. In other words, the four cutting edges 30a-d can be used while only rotating each individual reversible or indexable knife 12 a single time. In another embodiment, the tool 10 may remain fixed to the machine 100, and the individual reversible or indexable knives 12 may be rotated three separate times.

In the illustrated embodiment, the reversible or indexable knives 12 of the leveler saw 50 may each be rotated three times with respect to the saw 50, in order to utilize all four cutting edges 30a-d. However, in one embodiment, the leveler saw 50 may be configured such that it also can be flipped or reversed with respect to the machine. In the event that one or more of the reversible or indexable knives 12 on the roughing tool 10 or the leveler saw 50 are damaged during use, an operator may shut down the machine, remove and replace the individual damaged reversible or indexable knife 12 or knives, and then resume operation of the machine.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property of privilege is claimed are defined as follows:

1. A tool for a binding operation comprising:
a central portion configured to be mounted to a binding machine, wherein the tool is capable of being rotated with respect to the binding machine;
a circumferential edge extending around said central portion, the tool including a plurality of recesses defined in the tool adjacent said circumferential edge, said recesses spaced apart about said circumferential edge; and
a plurality of cutting knives removably attached to the tool, each said cutting knife disposed in one of said recesses, each said cutting knife including a plurality of cutting edges with each said cutting edge disposed at an angle with respect the other cutting edges, wherein each said cutting knife is capable of being removed from said one of said recesses, rotated with respect to said one of said recesses, and reattached to the tool within said recess in a different angular position with respect to said recess.

2. The tool of claim 1 wherein said tool includes a front surface, a rear surface opposite said front surface, said circumferential edge extending between said front surface and said rear surface perpendicular to said front surface and said rear surface, said recesses defined in said circumferential edge.

3. The tool of claim 2 wherein each said recess includes a first wall extending into said circumferential edge, a second wall extending into said circumferential edge and a floor extending between said first wall and said second wall.

4. The tool of claim 3 wherein said pair of walls are parallel to each other and are oriented at an oblique angle with respect to said front surface and said rear surface.

5. The tool of claim 5 wherein said angle is approximately 5 degrees.

6. The tool of claim 1 wherein each said cutting edge is beveled, wherein a first cutting edge engages said first wall of said recess and a second cutting edge engages said second wall of said recess.

7. The tool of claim 6 wherein said cutting knives are generally square, such that each cutting knife includes four said cutting edges.

8. The tool of claim 1 wherein the tool includes a front surface, a rear surface opposite said front surface and wherein said circumferential edge extends between said front and rear surfaces, said recesses defined in said front surface.

9. The tool of claim 8 wherein each said recess includes a first wall and a second wall, said first wall extending along a first line and said second wall extending along a second line, said first line intersecting said second line.

10. The tool of claim 9 wherein said first wall extends generally perpendicular to said second wall.

11. The tool of claim 10 including a first fastener hole defined within each said recess, a second fastener hole defined in each said cutting knife and a fastener extending through each said first fastener hole and each said second fastener hole to removably attached said cutting knives to the tool, wherein said second fastener hole is equidistant from at least a portion of each said cutting edge.

12. A book binding tool system comprising:
a roughing tool configured to be mounted for rotation on a book binding machine, said roughing tool having a front surface, a rear surface and a circumferential edge, said circumferential edge defining a plurality of roughing tool recesses;
a leveler saw configured to be mounted for rotation on a book binding machine, said leveler saw including a front surface, a rear surface and a circumferential edge, said front surface defining a plurality of leveler saw recesses extending to said circumferential edge; and
a plurality of cutting knives, each said cutting knife including multiple cutting edges oriented at angles with respect to one another, wherein one of said cutting knives is disposed in each roughing tool recess and one of said cutting knives is disposed in each leveler saw recess, said cutting knives capable of being removably attached within said roughing tool recesses and said leveler saw recesses in multiple positions, wherein each of said positions exposes a different one of said cutting edges.

13. The book binding tool system of claim 12 wherein said cutting knives each define a fastener hole, wherein at least a portion of each of said multiple cutting edges is spaced equidistant from said fastener hole.

14. The book binding tool system of claim 13 wherein each said cutting knife includes an upper surface and a lower surface, said cutting edges extending between said upper surface and said lower surface, wherein each said cutting edge is a beveled edge.

15. The book binding tool system of claim 14 wherein said roughing tool recesses each include a floor defining a fastener hole, said leveler saw recesses each including a floor defining a fastener hole, said cutting knives and said roughing tool recesses sized such that said lower surface of each said cutting knife contacts said floor of said roughing tool recess in any of said multiple positions, said cutting knives and said leveler saw sized such that said lower surface of said cutting knife contacts said floor of said leveler saw recess in each of said multiple positions.

16. The book binding tool system of claim 12 wherein each roughing tool recess includes a first wall and a second wall facing said first wall, said first wall and said second wall extending at an oblique angle with respect to said front and rear surfaces of said roughing tool.

17. The book binding tool system of claim 16 wherein said oblique angle is about 5 degrees.

18. The book binding tool system of claim 12 wherein said cutting knives are square, such that each cutting knife includes four cutting edges.

19. The book binding tool system of claim 12 wherein each said leveler saw recess includes a first wall and a second wall, said first wall contacting a first cutting edge of said cutting knife, said second wall contacting a second cutting edge of said cutting knife, said first and second edges of said cutting knife being adjacent to each other.

20. A book binding tool method comprising:
providing a roughing tool having a front surface, a rear surface, a circumferential edge and a plurality of roughing tool recesses defined in said circumferential edge;
providing a leveler saw having a front surface, a rear surface, a circumferential edge and a plurality of leveler saw recesses adjacent said circumferential edge;
providing a plurality of cutting knives, each said cutting knife having multiple cutting edges;
attaching one of said cutting knives into each said roughing tool recess in a first position;
attaching one of said cutting knives into each said leveler saw recess in a first position;
attaching said roughing tool to a machine with said front surface facing a first direction, said roughing tool attached to said machine such that it can rotate about an axis with respect to said machine;
attaching said leveler saw to a machine such that it can rotate about an axis with respect to said machine;
rotating said roughing tool and said leveler saw;
removing at least one of said cutting knives from one of said roughing tool and said leveler saw; and
reattaching said at least one of said cutting knives to said one of said roughing tool and said leveler saw in a second position that is different from said first position of said one of said roughing tool and said leveler saw.
